(19) United States
(12) Patent Application Publication
(10) Pub. No.: US 2008/0202350 A1
(43) Pub. Date: Aug. 28, 2008

(54) PROCESS FOR CONTROLLING THE COOKING PROCESS IN COMMERCIAL BATCH OVENS

(76) Inventor: Michael Maki, Seaside, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 12/038,636

(22) Filed: Feb. 27, 2008

Related U.S. Application Data
(60) Provisional application No. 60/939,002, filed on May 18, 2007.
(60) Provisional application No. 60/892,225, filed on Feb. 28, 2007.

(51) Int. Cl. A47J 27/00; F27D 19/00

(52) U.S. Cl. 99/330; 236/16

(57) ABSTRACT

A batch cooking oven and process wherein food product, e.g. meat portions is batch cooked in a cooking chamber using heated air flow. A controller can vary the rate of movement and/or position of the dampers to change the flow path of the heated air through the cooking chamber and thus improve the cooking consistency of the food product. In various embodiments, the rate of movement and/or positioning of the dampers may be variably controlled and/or may be based on output from sensors in the cooking chamber that monitor a condition (e.g. product temperature, humidity, flow rate, temperature, etc.)

### CROSS REFERENCE TO RELATED APPLICATIONS

This application is a non-provisional application of, and claims priority to, provisional application 60/939,002, filed on May 18, 2007, entitled “PROCESS FOR CONTROLLING THE COOKING PROCESS IN COMMERCIAL BATCH OVENS,” and provisional application 60/892,225, filed on Feb. 28, 2007, entitled “PROCESS FOR CONTROLLING THE COOKING PROCESS IN COMMERCIAL BATCH OVENS.” The specifications of the provisional applications are hereby incorporated in their entirety, except for those sections, if any, that are inconsistent with this specification.

### TECHNICAL FIELD

Embodiments of the invention pertain to commercial batch ovens, and in particular to the process for controlling the cooking process in commercial batch ovens.

### BACKGROUND

The processing of cooked meats often includes the use of large commercial batch oven or smokehouse cabinets to house racks of meat for extended predetermined periods of time to accomplish desired levels of cooking, smoking and moisture content. The products being processed have various temperatures and moisture levels, such large cabinets have difficulties in creating an even processing temperature and control humidity throughout the cabinet. As a result, portions of the batch are often undercooked (typically in the middle of the cabinet) while other portions are overcooked and excessively dried (typically towards the outer or side portions).

Attempts to create a uniform cooking/smoking environment for all product within a cabinet has historically been addressed by creating an airflow that brings heated and properly humidified air to the product, while removing the air that has been cooled and had its humidity modified by the product being processed. Currently, dampers are used to direct and adjust the air flow to and from the cabinet. The damper openings are opened and closed using various means of rotation, and generally using a coordinated and constant rate of opening and closing (i.e. the dampers move together the same amount and establish the same relative positions in the ducts.

At various positions of the rotation of the damper openings, the air flow rate differs and the location of where the flow is directed will change. Because these systems are unable to controllably regulate, accelerate and/or slow down the movement/rotation based on specific air flow needs, it has been fount that this creates inconsistent air flow and thus inconsistent heat and moisture flow through the cabinet.

Currently the variation of temperatures in ovens/smokehouses can be more than 10 degrees F. from desired levels. At the bottom corners of the cabinet, for example, is where product is typically first exposed to the newly introduced pre-heated air supply based on the current oven configurations. The constant oscillating movement of the dampers supplies airflow back and forth within the cabinet and exposes the bottom corners to up to 30% more of the air stream than the middle and upper portions of the cabinet. This occurs primarily when the dampers are in between a fully open and closed position, as the air flow is forced to go across the bottom of the cabinet each time the air flow changes sides from left to right, or right to left. Further, as the air flow path moves through the racks holding the product, the airflow temperature is reduced as the result of it absorbing moisture and colder temperature (heat transfer) from the product while migrating from the bottom of the cabinet to the return ducts at the top of the cabinet. The resultant temperature variations again cause inconsistencies in the cooking/smoking of processed product.

Additionally, current ovens utilize a stationary temperature probe that monitors the temperature of the airflow, which is commonly known as the Dry Bulb sensor/probe. Another stationary temperature probe (usually located next to the Dry Bulb probe) monitors the temperature at which water is evaporating within the cabinet, known as the Wet Bulb temperature. The Dry Bulb temperature and the Wet Bulb temperature can be correlated to a specific Relative Humidity.

In addition to monitoring the temperature and humidity, insertion probes may be used to monitor the internal temperature of the product(s) being cooked. Depending on the physical size of the smokehouse oven and/or the desired level of information required, there may be one or more (for example up to twelve) internal temperature probes placed throughout the cabinet. This data is recorded to ensure compliance with food safety mandates set forth by the USDA, and also to help establish a completed cooking cycle. Accordingly, products are cooked until the internal temperature of the ‘coldest’ piece of product reaches a desired set point temperature, which necessarily results in over-cooking the other products (typically located in the lower sections of the cabinet), creating a loss of yield in the over-cooked products. However, these probes are used strictly to monitor conditions and/or to serve as an indication of when the total cooking process should cease.

### DRAWINGS

Embodiments of the present invention will be readily understood by the written description along with reference to the accompanying renderings. Embodiments of the invention are illustrated by way of example and not by way of limitation in the accompanying pictures and/or figures.

FIG. 1 illustrates a cross sectional view of an oven in accordance with embodiments of the present invention;

FIG. 2 illustrates a cross sectional view of an oven in accordance with embodiments of the present invention;

FIG. 3 illustrates a cross sectional view of an oven in accordance with embodiments of the present invention;

FIG. 4 illustrates a cross sectional view of an oven in accordance with embodiments of the present invention;

FIG. 5 illustrates a cross sectional view of an oven in accordance with embodiments of the present invention; and

FIG. 6 illustrates a flow chart for controlling the cooking process in accordance with embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).” For the purposes of the present invention, the phrase “(A)B” means “(B) or (AB)”, that is, A is an optional element.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments, a method for controlling the cooking process in commercial ovens is provided, where the air flow is controlled to form a generally constant cooking environment. In various embodiments, the airflow to the cabinet may be changed and/or controlled by modifying the rate of movement of the dampers from a consistent rotation/oscillation to a variable rate, such that the constant air flow that tends to create the oversupply of heated air to the bottom corners of the cabinets can be reduced and/or eliminated. The result is a more uniform airflow to all areas of the cabinet and more consistent improved cooking/smoking result throughout the batch of product.

In various embodiments, a damper system may be used that is adapted to modulate the air flow of heated and/or moist air into a cabinet for the cooking or smoking of meat products. The damper system may utilize a variable rate of damper movement such that prolonged dwell at the various positions, such as the full open, full closed, and positions in between, may be reduced and/or avoided altogether by moving or rotating, the damper at a faster or slower rate as the oscillating air flow moves from side to side. This variation of rotation may be achieved using gearing, electronically controlled servo motors and other drivers. In various embodiments, the driver of the dampers may be configured to vary from a range of 0.2 rpm to 3 rpm, thereby causing the damper cycle from fully open to fully closed to move from one cycle to several cycles per minute.

In various embodiments one or more sensors adapted to detect various conditions, such as temperature, humidity, etc., may be coupled to a controller. The controller may be further coupled to the damper drivers and adapted to controllably modify the rate of damper rotation and/or damper position based on the sensor input, to achieve the desired temperature gradient, air flow and/or humidity.

In various embodiments, the rate of movement of the supply dampers may be modified based on feedback from internal temperature probes, such that the inconsistent supply of heated air to the products within the cabinet can be significantly reduced and/or eliminated. This results in a more uniform airflow around the products, and may help eliminate the over-cooking and yield loss of the products being cooked. In one embodiment, based on the internally sensed temperatures, the rate of movement (e.g. slowing down, speeding up, stopping) of the supply dampers may be modified to channel the airflow to specific areas within the oven cabinet, thereby reducing the product cooking differential. In various embodiments, the speed and/or position of the dampers may be controlled via user input.

Due to many different cook cycles of various products, the physical size and shape of the products, the positioning of the products in the cooking chamber (e.g. lying on a rack or hanging), and the formulation used to make the products, controlling the airflow within the cabinet can vary accordingly. Therefore, by actively controlling the supply dampers (which controls the airflow within the cabinet) during the complete cook cycle based on the internal temperature of the products, the yield loss/overcooking due to inconsistent airflow may be reduced. This may be accomplished for example, through coupling the sensors that are adapted to sense a condition (e.g. product internal temperature, humidity, air temperature, flow rate, etc) to a programmable electronic controller or computer, which in turn is programmed to determine the optimal location of airflow based on the relative readings throughout the cooking process. The damper drivers may then be variably and/or independently controlled by the programmable controller or computer consistent with the determined changes.

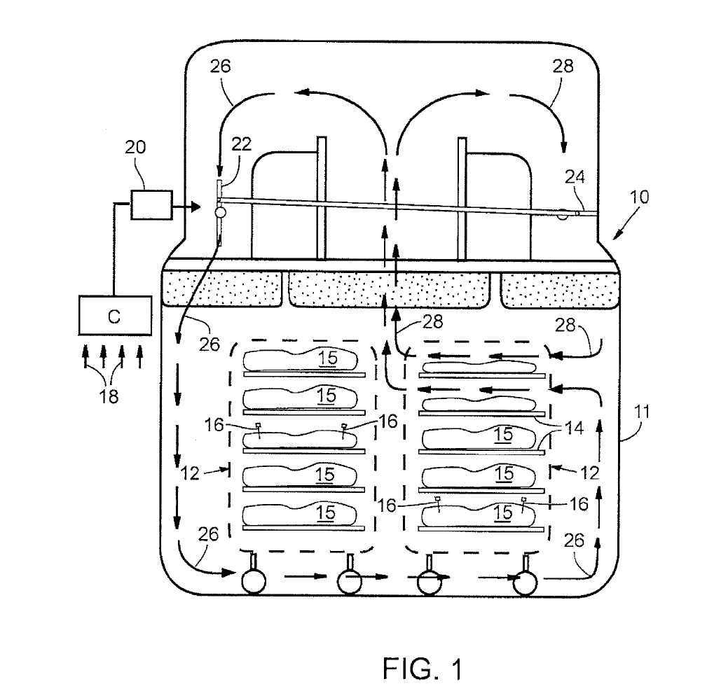

FIGS. 1-5 illustrate ovens in accordance with various embodiments, where the dampers have been actively controlled to different settings in order to modify the flow through the oven. In various embodiments, such damper movements may be in response to sensed conditions by sensors such as wet bulb sensors, dry bulb sensors, and/or internal temperature probes. In various embodiments, the rate of movement may vary from one position to another position.

FIG. 1 illustrates an oven with a first damper setting in accordance with various embodiments of the invention. Oven 10 includes a cooking chamber 11 with racks 12 having stacks of trays 14 adapted to hold food product 15 (e.g. meat) during a cooking cycle. In various embodiments the product may be hung or otherwise disposed in the cooking chamber. Internal temperature probes 16 may be inserted a strategic positions in the food products and coupled to a computer C via sensed condition inputs 18. Based on inputs 18, the computer C may analyze the sensed condition and determine the desired temperature changes for the various trays of food product 15, e.g. to obtain a consistent cooking of all food product contained throughout the interior of the oven 10. The computer C may then direct a controller 20 to controllably vary the rate of movement and/or position of the dampers 22/24 in order to achieve the desired cooking process state (e.g. temperature of air flow, rate of air flow, and path of air flow, humidity, etc.). In various embodiments, the controller and the computer may be separate components, and in other embodiments they may be integrated. In various embodiments, the variable control may be based on a user directed input as opposed to and/or in addition to the sensed condition.

A comparison of FIGS. 1-5 illustrates an example of how the dampers 22 and 24 may be variably controlled in order to alter the air flow path represented by arrows 26, 28, within the cooking chamber. In the illustrated embodiment, the airflow enters the sides of the cabinets and the return pull of air from the oven interior is at the top center of the oven. Other configurations may be used in accordance with various embodiments.

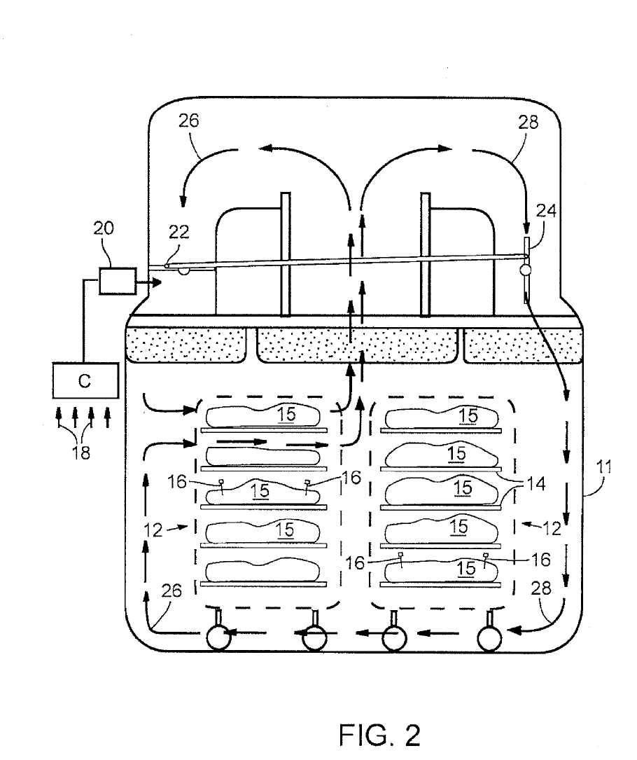

As illustrated in FIG. 1, the damper 22 is substantially fully open and damper 24 substantially fully closed. Minimal air flow 28 enters the right side past damper 24 and maximum air flow 26 enters at the left side past damper 22. The rapid movement of air flow 26 flows to the bottom and circulates counterclockwise and back to the center for departure from the cooking chamber 11. FIG. 2 shows the reverse, i.e. with the damper 22 substantially fully closed and the right damper 24 substantially fully open. In various embodiments, the dwell time at these positions may be controlled and varied as desired.

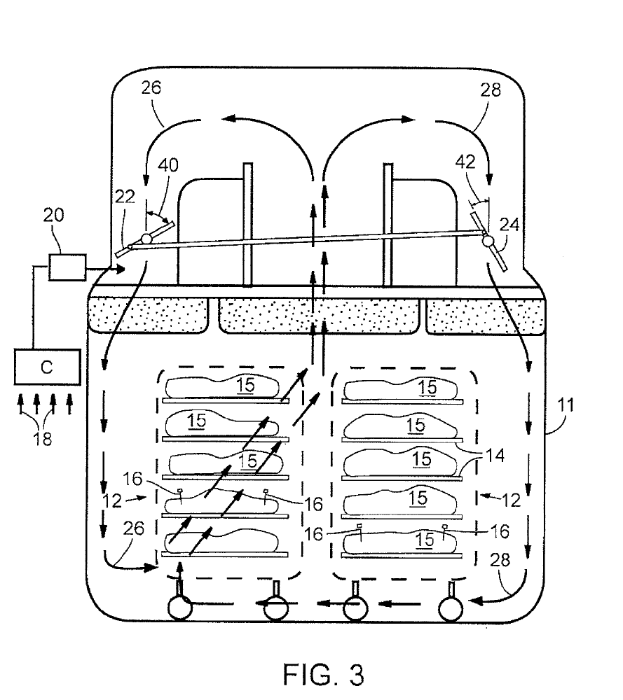

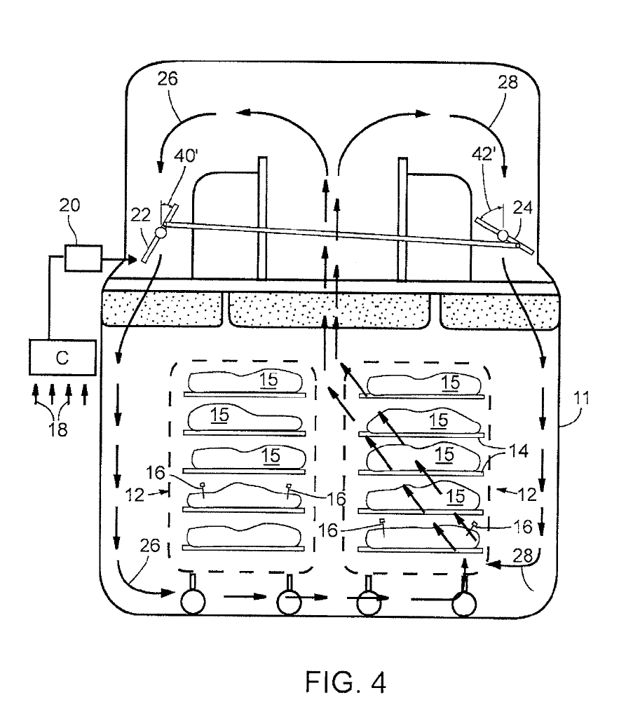

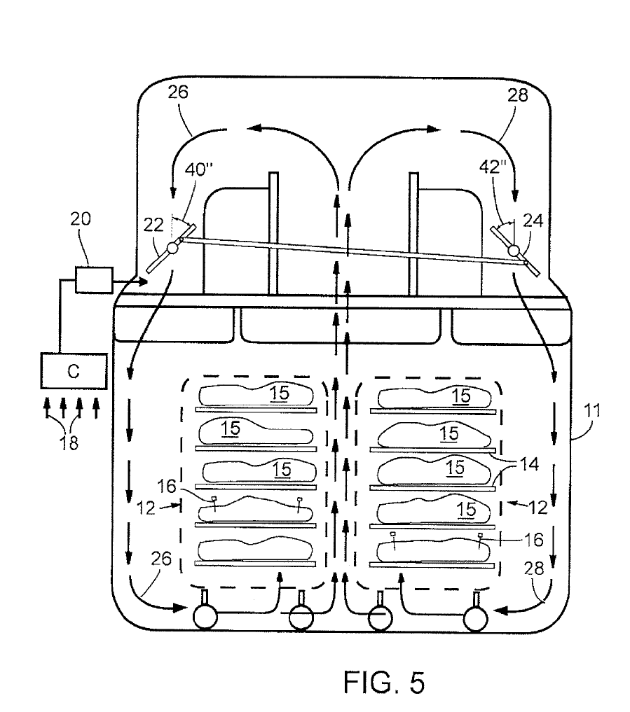

FIGS. 3, 4, and 5 illustrate the type of air flow achieved with damper 22 and 24 in various stages of partially opened and partially closed. For example FIG. 3 illustrates damper 22 at a first damper angle 40 with respect to the air flow, thus causing a more restricted flow of air. Damper 24 has a smaller second damper angle 42, thereby allowing more air to pass into the cooking chamber 11. As illustrated, this may induce a flow path across the product in a lower left to upper right gradient, thereby inducing further cooking of the product on rack 12. FIG. 4 illustrates generally the opposite, with the first damper angle 40′ being smaller than the first damper angle 42′, thereby inducing a lower right to upper left flow path. FIG. 5 illustrates the dampers 22 and 24 wherein the first damper angle 40″ and the second damper angle 42″ are set at the same angle to induce a more symmetric flow path. Again, the rate of damper movement between these positions may be varied by the controller in order to affect the flow path of the heated air.

In various embodiment, depending on the sensor output to the computer C, such as temperature from the internal temperature probes 16, the computer can cause the controller to independently vary the positions of the dampers 22/24 in order to alter the air flow 26/28 across the product 15 and thus achieve a more uniform cooking profile and/or alter the cooking rate of all product 15. The detection and adjustment process may continue throughout the cooking cycle to help achieve a finished product that is more uniformly cooked.

In various embodiments, additional sensor input may be provided to computer C, such as wet and dry bulb sensor data, which in turn may be factored into the variable control of the dampers 22/24. As these probes signal the computer/controller that measure a state within the oven is not consistent or desired, the computer can help redirect the cooking process (e.g. via air flow rate, air flow temperature and damper action) to equalize the cooking of the product. In various embodiments, the more than two air inputs, more than two dampers, and/or more than one exhaust may be used to control the air flow.

In various embodiments, the dampers may be not only be variably controllable as to rate of movement, but also be independently controllable, such they may move at different rates and/or attain different positions in order to further customize the flow path and further improve cooking consistency. In one embodiment, independent servo motors may be coupled to the dampers and based on input from the controller, independently vary the position and/or speed of the dampers.

Though not expressly described herein, other components of the oven that may be controlled and/or affected by the sensed condition output to the controller and/or computer, and include, but are not limited to, heaters that heat the air, fans that generate air movement, evaporators and/or condensers.

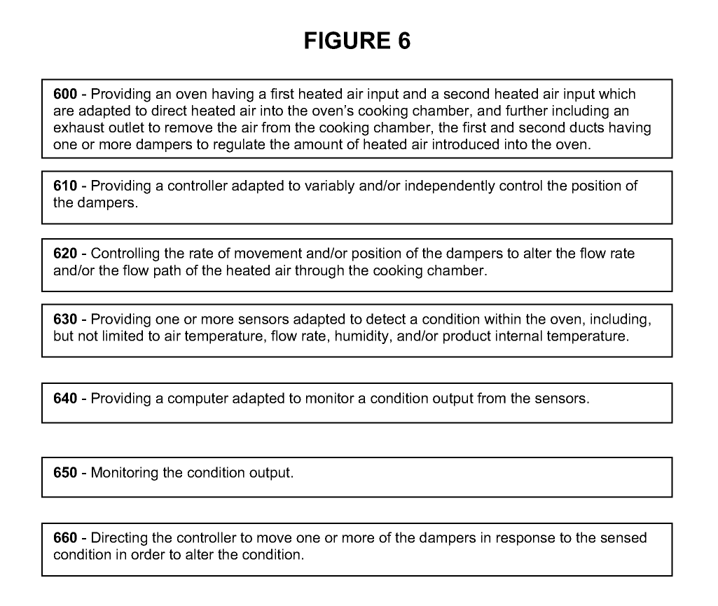

FIG. 6 illustrates an various embodiments of a method of cooking product in an oven, and which may include:
600—Providing an oven having a first heated air input and a second heated air input which are adapted to direct heated air into the oven's cooking chamber, and further including an exhaust outlet to remove the air from the cooking chamber, the first and second ducts having one or more dampers to regulate the amount of heated air introduced into the oven.
610—Providing a controller adapted to variably and/or independently control the position of the dampers.
620—Controlling the rate of movement and/or position of the dampers to alter the flow rate and/or the flow path of the heated air through the cooking chamber.

In various embodiments, the method may also include:
630—Providing one or more sensors adapted to detect a condition within the oven, including, but not limited to air temperature, flow rate, humidity, and/or product internal temperature.
640—Providing a computer adapted to monitor a condition output from the sensors.
650—Monitoring the condition output;
660—Directing the controller to move one or more of the dampers in response to the sensed condition in order to alter the condition.

In various embodiments, an objective of the invention is to obtain a more consistent cooking of food product being cooked by batch processing in an oven enclosure where cooking is achieved by the flow of heated air. Such objectives may be achieved by variably and/or independent control of the dampers. Further, using the various sensors within the oven to help dictate the various control of the dampers based on the cooking condition of the product may also achieve this objective.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A batch cooking oven utilizing heated air flow for cooking food product contained in the oven, the oven comprising:
a cooking chamber adapted to house one or more food portions in spaced apart relation;
at least two heated air inlets to the cooking chamber and an air outlet, each of the at least two heated air inlets includes a one or more dampers to control the heated air flow through the respective heated air inlet; and
a controller coupled to the dampers, the controller adapted to variably control the movement of the dampers during the cooking process to induce a change in a flow path of heated air passing through the cooking chamber.

2. The batch cooking oven as defined in claim 1, further comprising:
one or more sensors disposed in the cooking chamber adapted to detect a condition within the cooking chamber; and
wherein the controller is coupled to the one or more sensors and adapted to control the dampers based on the sensed condition.

3. The batch cooking oven as defined in claim 2, wherein the controller includes a computer adapted to receive the condition input from the one or more sensors, and wherein the computer determines the rate of movement between positions of the dampers needed to achieve a more consistent cooking of the food product.

4. The batch cooking oven as defined in claim 2, wherein the one or more sensors includes internal temperature probes disposed in selected portions of the one or more food products.

5. The batch cooking oven as defined in claim 2, wherein the sensed condition is at least one of air temperature, flow rate, humidity, and/or product internal temperature.

6. The batch cooking oven as defined in claim 1, wherein the dampers have a common control whereby opening of one damper produces closure of the other damper.

7. The batch cooking oven as defined in claim 1, wherein the dampers are independently controllable by the controller.

8. A method for batch cooking food products, comprising:
providing an oven having a first heated air inlet and a second heated air inlet adapted to direct heated air into a cooking chamber of the oven and an exhaust to remove the air from the cooking chamber, the first and second heated air inlets having one or more dampers adapted to regulate the flow of heated air introduced into the cooking chamber;
providing a controller adapted to variably control the rate of movement and/or position of the dampers; and
variably controlling the rate of movement and/or position of the dampers to alter a flow path of the heated air through the oven during the cooking cycle.

9. The method of claim 8, further comprising:
providing one or more sensors adapted to detect a condition within the cooking chamber;
detecting the condition; and
controlling the rate of movement and/or position of the dampers based on the detected condition to alter the detected condition.

10. The method of claim 9, further comprising:
providing a computer adapted to monitor a condition output from the sensors;
monitoring the condition input;
computing a new position for the dampers and a rate of movement to alter the flow path of the heated air to improve the consistency of a food product being cooked; and
causing the controller to adjust the dampers to alter the condition in the cooking chamber.

11. The method of claim 9, wherein the detecting the condition includes detecting at least a selected one of air temperature, flow rate, humidity, and/or product internal temperature.

12. The method of claim 8, wherein the controlling the position of the dampers includes independently controlling the dampers.
